(19) United States
(12) Patent Application Publication
(10) Pub. No.: US 2019/0373888 A1
(43) Pub. Date: Dec. 12, 2019

(54) SEED TREATMENT COMPOSITION

(71) Applicant: Valent U.S.A., Corporation, Walnut Creek, CA (US)

(72) Inventors: Jane Liu, Pleasanton, CA (US); Toshiya Ogawa, San Ramon, CA (US)

(21) Appl. No.: 16/003,499

(22) Filed: Jun. 8, 2018

(51) Int. Cl. A01N 37/18; A01N 43/78; A01N 43/653; A01N 43/12

(52) U.S. Cl. CPC A01N 37/18; A01N 43/12; A01N 43/653; A01N 43/78

(57) ABSTRACT

The present invention is generally directed to agricultural mixtures containing mandestrobin, ethaboxam, metalaxyl, metconazole and gibberellic acid 4/7 and methods of use thereof. The present invention further relates to seed treatment compositions containing mandestrobin, ethaboxam, metalaxyl, metconazole, gibberellic acid 4/7 and one or more excipients selected from the group consisting of an aluminum silicate hydroxide, a polyvinyl alcohol, sorbitol, glycerol, lignosulfonates and sodium or calcium salts thereof, a lignin, alkali, reaction product with formaldehyde and sodium bisulfite, an acetylenic diol based wetting and foam control agent, a wax emulsion in water, xanthan gum, 1, 2-benzisothiazolin-3-one, an ethylene-vinyl acetate copolymer, titanium dioxide, copper phthalocyanine, sodium salt of naphthalene sulfonate condensate, a potassium salt of polyoxyethylene tristyrylphenol phosphate, a silicone emulsion, triethanolamine, sodium tetraborate decahydrate, a mixture of 1.15% 5-chloro-2-methyl-4-isothiazolin-3-one and 0.35% 2-methyl-4-isothiazolin-3-one, smectite, citric acid, 35% graft copolymer and propylene glycol and methods of use thereof.

### FIELD OF THE INVENTION

The present invention is generally directed to agricultural mixtures containing mandestrobin, ethaboxam, metalaxyl, metconazole and gibberellic acid 4/7 and methods of use thereof. The present invention further relates to seed treatment compositions containing mandestrobin, ethaboxam, metalaxyl, metconazole, gibberellic acid 4/7 and one or more excipients selected from the group consisting of an aluminum silicate hydroxide, a polyvinyl alcohol, sorbitol, glycerol, lignosulfonates and sodium or calcium salts thereof, a lignin, alkali, reaction product with formaldehyde and sodium bisulfite, an acetylenic diol based wetting and foam control agent, a wax emulsion in water, xanthan gum, 1, 2-benzisothiazolin-3-one, an ethylene-vinyl acetate copolymer, titanium dioxide, copper phthalocyanine, sodium salt of naphthalene sulfonate condensate, a potassium salt of polyoxyethylene tristyrylphenol phosphate, a silicone emulsion, triethanolamine, sodium tetraborate decahydrate, a mixture of 1.15% 5-chloro-2-methyl-4-isothiazolin-3-one and 0.35% 2-methyl-4-isothiazolin-3-one, smectite, citric acid, 35% graft copolymer and propylene glycol and methods of use thereof.

### BACKGROUND OF THE INVENTION

Seed rot, seedling decay (damping-off), and seedling disease can reduce plant emergence and decrease yields. These blights are caused by a number of pathogens. Unfortunately, contemporary agronomic practices are exacerbating the problem. The current trend towards early planting in cold, wet soils, reduced tillage or no-till fields favors an environment conducive to the pathogen growth over the growth and development of the planted seed.

Seed treatments are an efficient method used to control pathogens as the actives are applied directly to the seed and are present on the seed and in the seed zone, protecting the germinating seed and seedling during early growth and development. Seed treatments are applied prior to planting. It is important to utilize approved commercial, recently calibrated, seed treatment equipment to insure excellent seed coverage and uniformity over the seed-coats. This method of application requires seed treating personnel to use and safely operate seed treatment equipment. Providing pre-treated seeds to end users is an economical alternative to drench, in-furrow, or foliar applications of seed or plant protection products.

The widespread use of foliar fungicides has resulted in a build-up of resistance in the pathogens. Accordingly, the effectiveness of presently used fungicides is diminishing if they are applied alone.

Solo fungicide applications used frequently and without alternating or mixing with fungicides of different modes of action has led to pathogen resistance. For example, Phytophthora and downy mildew fungi have shown resistance to metalaxyl. Rhizoctonia has shown resistance to azoxystrobin. Pathogen resistance is a major concern because it can cause sudden crop failures resulting in severe reductions in crop yields.

Accordingly, there is a need in the art for effective pesticidal seed treatments, especially fungicidal treatments. The seed treatments should have broad spectrum activity to protect the seed and seedlings from the diverse fungal pathogens present in the soil, which discourage pesticide resistance or tolerance, have little-to-no phytotoxicity, and should be safe and easy for the seed treat applicator and end user.

### SUMMARY OF THE INVENTION

In one aspect, the invention is directed to agricultural mixtures comprising mandestrobin, ethaboxam, metalaxyl, metconazole and gibberellic acid 4/7.

The present invention is further directed to a seed treatment composition comprising mandestrobin, ethaboxam, metalaxyl, metconazole, gibberellic acid 4/7 and one or more excipients selected from the group consisting of an aluminum silicate hydroxide, a polyvinyl alcohol, sorbitol, glycerol, lignosulfonates and sodium or calcium salts thereof, a lignin, alkali, reaction product with formaldehyde and sodium bisulfite, an acetylenic diol based wetting and foam control agent, a wax emulsion in water, xanthan gum, 1, 2-benzisothiazolin-3-one, an ethylene-vinyl acetate copolymer, titanium dioxide, copper phthalocyanine, sodium salt of naphthalene sulfonate condensate, a potassium salt of polyoxyethylene tristyrylphenol phosphate, a silicone emulsion, triethanolamine, sodium tetraborate decahydrate, a mixture of 1.15% 5-chloro-2-methyl-4-isothiazolin-3-one and 0.35% 2-methyl-4-isothiazolin-3-one, smectite, citric acid, 35% graft copolymer and propylene glycol.

In another aspect, the invention is directed to methods for controlling or preventing pest damage of plants comprising applying agricultural mixtures or seed treatment compositions of the present invention to a plant propagation material.

### DETAILED DESCRIPTION OF THE INVENTION

In one embodiment, the present invention is directed to agricultural mixtures comprising mandestrobin, ethaboxam, metalaxyl, metconazole and gibberellic acid 4/7.

In another embodiment, the present invention is directed to a seed treatment composition comprising mandestrobin, ethaboxam, metalaxyl, metconazole, gibberellic acid 4/7 and one or more excipients selected from the group consisting of an aluminum silicate hydroxide, a polyvinyl alcohol, sorbitol, glycerol, lignosulfonates and sodium or calcium salts thereof, a lignin, alkali, reaction product with formaldehyde and sodium bisulfite, an acetylenic diol based wetting and foam control agent, a wax emulsion in water, xanthan gum, 1, 2-benzisothiazolin-3-one, an ethylene-vinyl acetate copolymer, titanium dioxide, copper phthalocyanine, sodium salt of naphthalene sulfonate condensate, a potassium salt of polyoxyethylene tristyrylphenol phosphate, a silicone emulsion, triethanolamine, sodium tetraborate decahydrate, a mixture of 1.15% 5-chloro-2-methyl-4-isothiazolin-3-one and 0.35% 2-methyl-4-isothiazolin-3-one, smectite, citric acid, 35% graft copolymer and propylene glycol.

As used herein, “plant propagation material” refers to seeds, bulbs, rhizomes and tubers.

In a preferred embodiment, the plant propagation material is a seed. In a more preferred embodiment, the mixtures of the present invention are applied to the seeds before they are planted.

Aluminum silicate hydroxide may be present in compositions of the present invention at a concentration from about 1% to 50% w/w, more preferably from 10% to about 30% w/w, and most preferably about 20% w/w. Continental clay (kaolin; CAS #1332-58-7) is one source of aluminum silicate hydroxide.

Polyvinyl alcohol may be present in compositions of the present invention at a concentration from about 0.1% to 15% w/w, more preferably from 1% to about 10%, and most preferably about 3.0% w/w. Selvol® 24-203 (CAS #25213-24-5) is one source of polyvinyl alcohol.

Sorbitol may be present in compositions of the present invention at a concentration from about 0.1% to 15% w/w, more preferably from 1% to about 10% w/w, and most preferably about 3.5% w/w. D-sorbitol (CAS #50-70-4) is one source of sorbitol.

Glycerol (CAS #56-81-5) may be present in compositions of the present invention at a concentration from about 0.1% to 15% w/w, more preferably from 1% to about 10% w/w, and most preferably about 5% w/w.

Lignosulfonates and sodium or calcium salts thereof may be present in compositions of the present invention at a concentration from about 0.01% to 1% w/w, more preferably from 0.1% to about 0.5% w/w, and most preferably about 0.15% w/w. A preferred lignosulfonate is a sodium lignosulfonate. Kraftsperse® 25M (CAS #68512-35-6) is one source of sodium lignosulfonate.

A lignin, alkali, reaction product with formaldehyde and sodium bisulfite may be present in compositions of the present invention at a concentration from about 0.01% to 5% w/w, more preferably from 0.1% to about 1% w/w, and most preferably about 0.6% w/w. Reax® 907 is one source of a lignin, alkali, reaction product with formaldehyde and sodium bisulfite.

An acetylenic diol-based wetting and foam control agent may be present in compositions of the present invention at a concentration from about 0.001% to 1% w/w, more preferably from 0.01% to about 1% w/w, and most preferably about 0.08% w/w. Surfynol® 104 PG (CAS #126-86-8) is one source of an acetylenic diol-based wetting and foam control.

A wax emulsion in water may be present in compositions of the present invention at a concentration from about 1% to 15% w/w, more preferably from 1% to about 5% w/w, and most preferably about 2.5% w/w. Michem® Lube 156 PFP (CAS #9002-88-4) is one source of a wax emulsion.

Xanthan gum may be present in compositions of the present invention at a concentration from about 0.01% to 1% w/w, more preferably from 0.1% to about 1% w/w, and most preferably about 0.2% w/w. Kelzan® CC is one source of xanthan gum.

1, 2-benzisothiazolin-3-one may be present in compositions of the present invention at a concentration from about 0.01% to 1% w/w, more preferably from 0.1% to about 1% w/w, and most preferably about 0.24% w/w. Proxel® GXL (CAS #2634-33-5) is one source of 1, 2-benzisothiazolin-3-one.

An ethylene-vinyl acetate copolymer in water may be present as a water-based adhesive in compositions of the present invention at a concentration from about 0.1% to 10% w/w, more preferably from 1% to about 5% w/w, and most preferably about 3% w/w. Aquence producer BG 0271 is one source of an ethylene-vinyl acetate copolymer in water.

Titanium dioxide may be present in compositions of the present invention at a concentration from about 0.1% to 10% w/w, more preferably from 1% to about 5% w/w, and most preferably about 4% w/w. Sunag® APE free blue (CAS #13463-67-7) is one source of titanium dioxide.

Copper phthalocyanine may be present in compositions of the present invention at a concentration from about 0.1% to 10% w/w, more preferably from 1% to about 5% w/w, and most preferably about 5% w/w. Sunag® APE free white (CAS #147-14-8) is one source of titanium dioxide.

Sodium salt of naphthalene sulfonate condensate may be present in compositions of the present invention at a concentration from about 0.001% to 1% w/w, more preferably from 0.01% to about 1% w/w, and most preferably about 0.06% w/w. Morwet® D425 is one source of a sodium salt of naphthalene sulfonate condensate.

A potassium salt of polyoxyethylene tristyrylphenol phosphate may be present in compositions of the present invention at a concentration from about 0.001% to 1% w/w, more preferably from 0.01% to about 1% w/w, and most preferably about 0.02% w/w. Stepfac™ TSP PE-K (CAS #163436-84-8) is one source of a potassium salt of a polyoxyethylene tristyrylphenol phosphate.

A silicone emulsion may be present in compositions of the present invention at a concentration from about 0.001% to 1% w/w, more preferably from 0.01% to about 1% w/w, and most preferably about 0.02% w/w. Xiameter® AFE-0010 (CAS #63148-62-9) is one source of silicone emulsion.

35% graft copolymer may be present in compositions of the present invention at a concentration from about 0.001% to 1% w/w, more preferably from 0.01% to about 1% w/w, and most preferably about 0.02% w/w. Tersperse® 2500 is one source of 35% graft copolymer.

Triethanolamine (CAS #102-71-6) may be present in compositions of the present invention at a concentration from about 0.001% to 1% w/w, more preferably from 0.01% to about 1%, and most preferably about 0.01% w/w.

Sodium tetraborate decahydrate (CAS #1303-96-4) may be present in compositions of the present invention at a concentration from about 0.001% to 1% w/w, more preferably from 0.01% to about 1% w/w, and most preferably about 0.01% w/w.

A mixture of 1.15% 5-chloro-2-methyl-4-isothiazolin-3-one (CAS #26172-55-4) and 0.35% 2-methyl-4-isothiazolin-3-one (CAS #2682-20-4) may be present in compositions of the present invention at a concentration from about 0.00001% to 1% w/w, more preferably from 0.0001% to about 1% w/w, and most preferably about 0.0002% w/w.

Smectite may be present in compositions of the present invention at a concentration from about 0.01% to 1% w/w, more preferably from 0.05% to about 1%, and most preferably about 0.5% w/w. Vengel B (CAS #12199-37-0) is one source of smectite.

Citric acid (CAS #77-92-9) may be present in compositions of the present invention at a concentration from about 0.001% to 1% w/w, more preferably from 0.01% to about 1% w/w, and most preferably about 0.05% w/w.

Propylene glycol (CAS #57-55-6) may be present in compositions of the present invention at a concentration from about 0.1% to 10% w/w, more preferably from 1% to about 10% w/w, and most preferably about 5% w/w

A 90.0 to 99.9% technical powder was used as the source of mandestrobin (CAS #173662-97-0).

A 90.0 to 99.9% technical powder was used as the source of ethaboxam (CAS #162650-77-3).

A 90.0 to 99.9% technical powder was used as the source of metalaxyl (CAS #57837-19-1).

A 90.0 to 99.9% technical powder was used as the source of metconazole (CAS #125116-23-6).

A 90 to 99.9% technical powder was used as the source of gibberellic acid 4/7 (CAS #468-44-0).

In another embodiment, the present invention is directed to a method of controlling weeds comprising applying a composition of the invention to a weed or an area in need of weed control.

Throughout the application, the singular forms “a,” “an,” and “the” include plural reference unless the context clearly dictates otherwise.

As used herein, all numerical values relating to amounts, weight percentages and the like are defined as “about” or “approximately” each particular value, plus or minus 10%. For example, the phrase “about 5.0% w/w” is to be understood as “from 4.5% to 5.5% w/w.” Therefore, amounts within 10% of the claimed values are encompassed by the scope of the claims.

These representative embodiments are in no way limiting and are described solely to illustrate some aspects of the invention.

Further, the following examples are offered by way of illustration only and not by way of limitation.

### EXAMPLES

### Example 1—A Seed Treatment Clay Composition

TABLE 1
Seed treatment clay composition

| Ingredients | CAS# | w/w % |
|---|---|---|
| Mandestrobin TG (90.4%) | 173662-97-0 | 1.22 |
| Ethaboxam TG (99.5%) | 162650-77-3 | 0.834 |
| Metalaxyl (98.5%) | 57837-19-1 | 0.449 |
| Metconazole (98.5%) | 125116-23-6 | 0.169 |
| Gibberellic Acid 4 + 7 | 468-44-0 | 0.009 |
| Continental Clay | 1332-58-7 | 20.00 |
| Selvol ® 24-203 | 25213-24-5 | 3.00 |
| Sorbitol Soln (70%) | 50-70-4 | 3.67 |
| Glycerol | 56-81-5 | 5.12 |
| Kraftsperse ® 25M | 68512-34-5 | 0.15 |
| Reax ® 907 | 68512-35-6 | 0.60 |
| Morwet ® D425 | n/a | 0.06 |
| Stepfac ® TSP PE-K (40%) | 163436-84-8 | 0.02 |
| Surfynol ® 104 PG | 126-86-8 | 0.08 |
| Michem ® Lube-156PFP | 9002-88-4 | 2.58 |
| Kelzan ® CC | 11138-66-2 | 0.21 |
| Proxel ® GXL | 2634-33-5 | 0.25 |
| Aquance ® producer BG0271 | n/a | 3.09 |
| Sunag ® APE Free Blue | 13463-67-7 | 4.00 |
| Sunag ® APE Free White | 147-14-8 | 5.00 |
| Xiameter ® AFE-0010 | 63148-62-9 | 0.003 |
| Water | 7732-18-5 | 49.49 |

Ingredients were mixed until well blended. The composition was stable upon blending.

### Example 2—A Seed Treatment Blend Composition

TABLE 2
Seed treatment blend composition

| Ingredients | CAS# | w/w % |
|---|---|---|
| Mandestrobin TG (90.4%) | 173662-97-0 | 1.219 |
| Ethaboxam TG (99.5%) | 162650-77-3 | 0.833 |
| Metalaxyl (98.5%) | 57837-19-1 | 0.447 |
| Metconazole (98.5%) | 125116-23-6 | 0.167 |
| Gibberellic Acid 4 + 7 | 468-44-0 | 0.009 |
| Citric acid | 77-92-9 | 0.050 |
| Vengel B | 12199-37-0 | 0.500 |
| Sodium tetraborate decahydrate | 1303-96-4 | 0.005 |
| Triethanolamine | 102-71-6 | 0.007 |
| Selvol ® 24-203 | 25213-24-5 | 0.023 |
| Sorbitol Soln (70%) | 50-70-4 | 0.274 |
| Glycerol | 56-81-5 | 10.19406 |
| Propylene glycol | 57-55-6 | 5.000 |
| Tersperse ® 2500 | n/a | 0.004 |
| Reax ® 907 | 68512-35-6 | 0.500 |
| Morwet ® D425 | n./a | 0.123 |
| Stepfac ® TSP PE-K (40%) | 163436-84-8 | 0.047 |
| Surfynol ® 104 PG | 126-86-8 | 0.054 |
| Michem ® Lube-156PFP | 9002-88-4 | 3.14684 |
| Kelzan ® CC | 11138-66-2 | 0.16247 |
| Proxel ® GXL | 2634-33-5 | 0.163 |
| Aquance ® producer BG0271 | n/a | 3.094 |
| Sunag ® APE Free Blue | 13463-67-7 | 28.000 |
| Sunag ® APE Free White | 147-14-8 | 5.000 |
| Xiameter ® AFE-0010 | 63148-62-9 | 0.003 |
| Water | 7732-18-5 | 40.9723 |

Ingredients were mixed until well blended. The composition was stable upon blending.

1. An agricultural composition comprising a mixture of mandestrobin,
ethaboxam, metalaxyl, metconazole and gibberellic acid 4/7.

2. A seed treatment composition comprising mandestrobin, ethaboxam, metalaxyl, metconazole, gibberellic acid 4/7 and one or more excipients selected from the group consisting of an aluminum silicate hydroxide, a polyvinyl alcohol, sorbitol, glycerol, lignosulfonates and sodium or calcium salts thereof, a lignin, alkali, xanthan gum, 1, 2-benzisothiazolin-3-one, titanium dioxide, copper phthalocyanine, a potassium salt of polyoxyethylene tristyrylphenol phosphate, triethanolamine, sodium tetraborate decahydrate, smectite, citric acid, and propylene glycol.

3. A method of controlling or preventing pest damage to a growing plant comprising applying the composition of claim 1 onto a plant propagation material.

4. A method of controlling or preventing pest damage to a growing plant comprising applying the composition of claim 2 onto a plant propagation material.
